(19) United States
(12) Patent Application Publication
(10) Pub. No.: US 2008/0028516 A1
(43) Pub. Date: Feb. 7, 2008

(54) Sling seat

(75) Inventor: Katsumi Morishima, Ichinomiya-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: MORITOH CO., LTD., Ichinomiya-shi (JP)

(21) Appl. No.: 11/646,440

(22) Filed: Dec. 28, 2006

(30) Foreign Application Priority Data
Aug. 4, 2006 (JP) 2006-213983

(51) Int. Cl. A61G 7/14; A61G 1/00

(52) U.S. Cl. 5/89.1

(57) ABSTRACT

A sling seat includes a base cloth formed sufficiently long at the top to reach a head of a person requiring nursing care with a large physique who sits in the seat, and a pillow for supporting a back of the head of the person requiring nursing care in the seat so that the back of the head does not sink into the upper portion of the base cloth. The pillow is attached to an upper portion of the base cloth, and a vertical position of the pillow can be adjusted to match the actual body size of the person requiring nursing care in the seat.

### TECHNICAL FIELD

The present invention relates to a sling seat for use when lifting a person requiring nursing care, such as a sick person, an elderly, enfeebled person, or the like.

### BACKGROUND OF THE INVENTION

Conventionally, when a person requiring nursing care is moved into or out of a bed, wheelchair, toilet seat, bath, or the like, a sling seat is used to ensure the safety and the like of the person requiring nursing care and to reduce the burden on the caregiver. The sling seat may be a so-called half type sling seat 100, as shown in FIG. 15, which supports an area lower than the neck of the person in the seat. Its advantage is that it can be used easily, but it cannot be used for a person whose neck has little weight-bearing strength. (Japanese Patent Application Publication No. JP-A-2001-87324)

To handle a person whose neck has little weight-bearing strength, either a separate device to lift and support the head is used at the same time as the sling seat, or a so-called full type sling seat is used in which the seat extends above the head and supports the head.

### SUMMARY OF THE INVENTION

However, when the device that is separate from the sling seat is used, the head of the person in the seat sometimes slips off of the device while the person is being lifted, so that the support for the head is suddenly removed. Also, when a sling seat that extends above the head is used, the person's head and trunk are enveloped by the seat during lifting, so that the neck of the person in the seat sometimes droops forward. To avoid the forward drooping, a member such as a towel, for example, that makes contact with the back of the head is simply inserted such that it is interposed between the sling seat and the person in the seat. But the member slips out right away, so the head and neck cannot be supported stably.

Therefore, an object of the present invention is to provide a sling seat that can lift a person requiring nursing care whose neck has little weight-bearing strength while stably supporting the person's head and neck.

In order to achieve the object described above, the sling seat according to the present invention includes a base cloth formed sufficiently long at the top to reach the head of a person requiring nursing care with a large physique who sits in the seat, and a pillow for supporting the back of the head of the person requiring nursing care in the seat so that the back of the head does not sink into the upper portion of the base cloth. The pillow is attached to the upper portion of the base cloth, and the vertical position of the pillow can be adjusted to match the actual body size of the person requiring nursing care in the seat.

In this specification, “person” means the person requiring nursing care. “Up” means the direction in which the head of the person in the seat is positioned when the sling seat is in use, and “down” means the direction in which the legs of the person in the seat are positioned when the sling seat is in use. Also, “front side” means the side with which the person in the seat is in contact when the sling seat is in use, and “rear side” means the side with which the person in the seat is not in contact when the sling seat is in use. Also, a “person with a large physique” is a person whose body is large relative to the general majority of persons requiring nursing care. Also, “the back of the head” includes not only the rear side of the head, but may also include the rear side of the neck. Generally, for holding the head and neck stably during lifting, of the area in the back of the head, it is considered desirable to support the area below the cranium from the mastoid process to the seventh cervical vertebra. It is desirable to support that area in the present invention as well.

The vertical dimension of the pillow is not limited in particular, but it is preferably from 5 to 18 centimeters, and more preferably from 7 to 15 centimeters. If the size is outside the range of from 5 to 18 centimeters, it tends to become difficult to support the area from the mastoid process to the seventh cervical vertebra. Also, where the vertical position of the pillow is adjusted by wrapping the upper portion of the base cloth around the pillow, as described below, it is desirable for the upper limit on the vertical dimension of the pillow to be 15 centimeters so that the adjustment pitch at each half-wrapping does not become too large.

The core material of the pillow is not limited in particular, but for holding the head and neck stably during lifting, a foam resin body, a balloon, or the like, in which rigidity and elasticity are balanced, can be given as examples. The shape of the foam resin body is not limited in particular, but for example, it may be molded to a prescribed shape, a flattened cylinder, or the like.

The mode of the balloon is not limited in particular. Considering the state of contact with the back of the head, a balloon with adjustable internal pressure may be given as a example, and an aggregation of small balloons (air cells) may also be used. Also, a design in which the balloon itself is easily removable from the pillow may be employed. By using a sling seat with a pillow in which a core material is a balloon when the person is in a bath, the effect that the buoyancy of the balloon prevents the person's head from being submerged in the bathtub can be obtained. Also, by employing the balloon which is easily removable from the pillow, the sling seat can be easily washed.

The mode of attaching the pillow and the mode of adjusting the vertical position of the pillow are not limited in particular, but the following are provided as examples:

(a) A mode in which the pillow is attached to the top end of the upper portion of the base cloth such that the attachment position cannot change, and the vertical position of the pillow is adjusted by wrapping the upper portion of the base cloth around the pillow.

(b) A mode in which the pillow is attached to the top end of the upper portion of the base cloth such that the attachment position cannot change, and the vertical position of the pillow is adjusted by shifting the pillow to give slack to the base cloth in the area below the pillow.

(c) A mode in which the pillow is attached to the upper portion of the base cloth such that the attachment position can change, and the vertical position of the pillow is adjusted by changing the attachment position on the upper portion of the base cloth.

(d) A mode in which a plurality of inflatable pillows are attached to the upper portion of the base cloth in a plurality of vertical positions such that none of the attachment positions can change, and the vertical position of the pillow is adjusted by changing which pillow is inflated.

The mode of a coupling member for coupling the sling seat to a hanging member of a care lift (a member for lifting the sling seat in use) is not limited in particular, but for example, the member may be an extension of a reinforcing strap or the like on an outer edge of the sling seat, or a strap or a loop that is separate from the sling seat.

The attachment position of the coupling member (for example, a lift strap, and the like) for lifting the sling seat to the base cloth is not limited in particular. The coupling member may be attached to the upper portion, the middle portion in the vertical direction, or the lower portion of the base cloth. However, it is preferable that two of the coupling members are configured such that they can be joined to the base cloth in the vicinity of the pillow. In particular, where the pillow is wrapped in the base cloth as in (a) above, it is preferable that two of the coupling members for lifting the sling seat are configured such that they can be joined to the base cloth at immediate both lateral sides of the pillow so that the two coupling members are positioned at the center of the portion that is wrapped in the base cloth.

The following are examples of the mode that two coupling members are configured such that they can be joined to the base cloth in the vicinity of the pillow:

(a) A mode in which two coupling members are joined directly to the base cloth at immediate both lateral sides of the pillow.

Examples of ways of joining include joining by tying the coupling members to the pillow, joining by passing the coupling members through loops that are provided on the pillow, sewing the coupling members to the base cloth at immediate both lateral sides of the pillow, and the like.

(b) A mode in which two coupling members are joined to coupling devices that are attached to the base cloth at immediate both lateral sides of the pillow.

Examples of the coupling devices include buckles, loop-shaped straps, ladders, and the like.

As a way of lifting the pillow using the coupling members that are joined to the base cloth at immediate both lateral sides of the pillow, the coupling members may be directly coupled to the hanging member of the care lift, or may be coupled to another coupling members which are configured to be coupled to the hanging member directly for coupling the sling seat to the hanging member of the care lift.

The method for coupling the coupling members that are joined to the base cloth at immediate both lateral sides of the pillow to the another coupling members that are configured to be coupled directly to the hanging member of the care lift is not limited in particular, and examples thereof include a method in which loops are provided at the ends of the coupling members joined to the base cloth at immediate both lateral sides of the pillow, and the loops are tied to the another members, a method in which hooks are provided at the ends of the coupling members joined to the base cloth at immediate both lateral sides of the pillow and the hooks are engaged with the another coupling members.

As a method for lifting the thighs of the person in the seat, a method may be used in which the thighs are enveloped from the side and lifted in the same manner as the torso, or a method may be used in which the thighs are wrapped from between the thighs and lifted.

According to the present invention, a sling seat can be provided that can lift a person requiring nursing care whose neck has little weight-bearing strength while stably supporting the person's head and neck.

### BRIEF DESCRIPTION OF THE DRAWINGS

FIG. 1 is a perspective view showing a sling seat according to a first embodiment of the present invention in its in-use state;

FIGS. 2A and 2B are partial perspective views showing differences in the state of use of the sling seat of the same due to differences in the physique of the person in the seat;

FIGS. 3A to 3C are partial perspective views showing states adjusting a position of a pillow for the sling seat of the same;

FIG. 4 is a plan view of a rear side of the sling seat of the same;

FIGS. 5A and 5B are plan views of members of the sling seat of the same;

FIG. 6 is a plan view of another mode of the sling seat of the same;

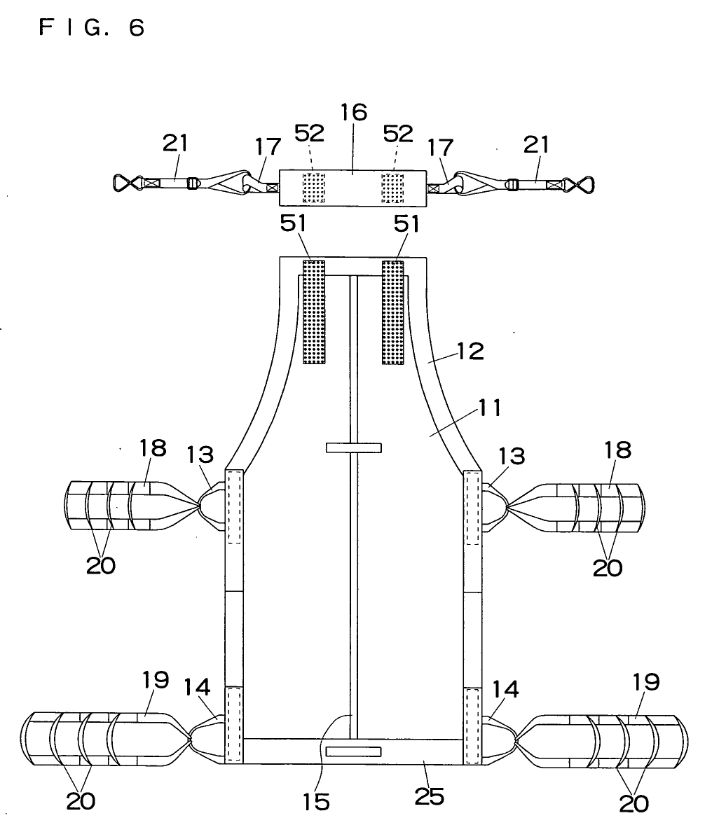

FIG. 7 is a perspective view showing a sling seat according to a second embodiment of the present invention in its in-use state;

FIG. 8 is a plan view of a rear side of the sling seat of the same;

FIGS. 9A and 9B are plan views of members of the sling seat of the same;

FIG. 10 is a plan view of a rear side of the sling seat according to a third embodiment of the present invention;

FIG. 11 is a perspective view showing a sling seat according to a fourth embodiment of the present invention in its in-use state;

FIG. 12 is a plan view of a rear side of the sling seat of the same;

FIG. 13 is a plan view of members of the sling seat of the same;

FIGS. 14A to 14C are schematic views showing changes in the state of use of the sling seat of the same; and

FIG. 15 is a perspective view showing a conventional sling seat in its in-use state.

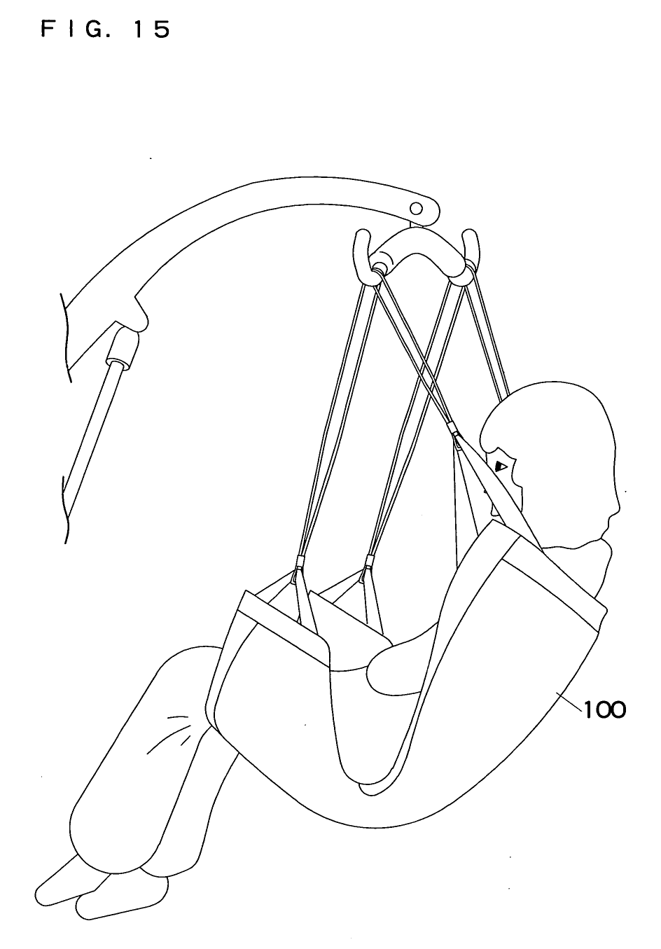

### DETAILED DESCRIPTION OF THE INVENTION

A sling seat includes a base cloth which is formed sufficiently long at the top to reach the head of a person requiring nursing care with a large physique who sits in the seat, and a pillow having a vertical dimension of from 7 to 15 centimeters for supporting the back of the head of the person in the seat such that the back of the head does not sink into the upper portion of the base cloth. The pillow is attached to the top end of the upper portion of the base cloth such that the attachment position cannot change. The seat is configured such that the vertical position of the pillow can be adjusted up and down by wrapping the upper portion of the base cloth around the pillow so as to match the position of the pillow to the actual body size of the person in the seat. Also, two of coupling members for lifting the sling seat are configured such that they can be joined to the base cloth at immediate both lateral ends of the pillow.

### First Embodiment

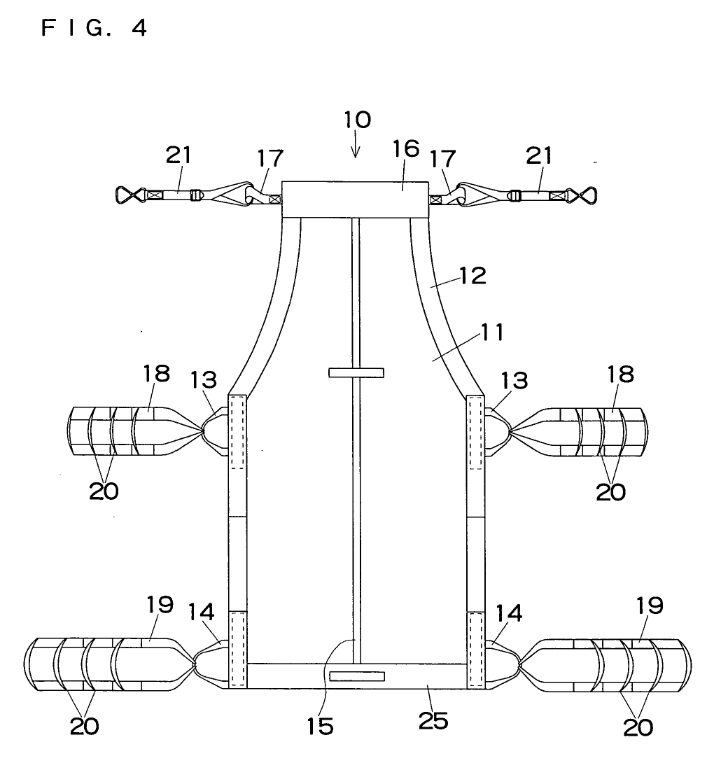

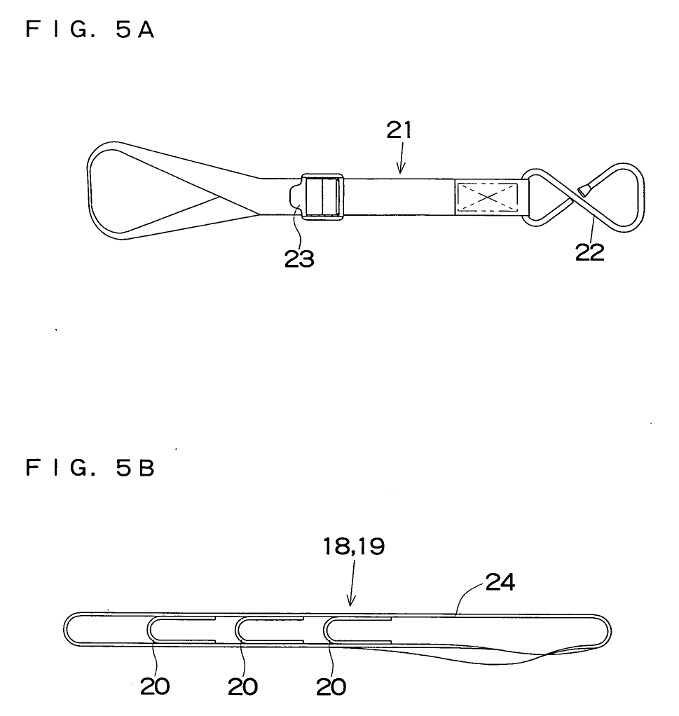

A first embodiment of the present invention will be explained below with reference to drawings. A sling seat 10 according to the first embodiment, as shown in FIG. 4, FIG. 5A, and FIG. 5B, includes a base cloth 11 and a pillow 16. The base cloth 11 supports from the thighs to the back of a person sitting in the seat and is formed sufficiently long at the top to reach the head of a person with a large physique. The pillow 16 is attached to a top end of an upper portion of the base cloth 11 in a fixed position and supports the back of the head of the person in the seat such that the back of the head does not sink into the upper portion of the base cloth 11.

The base cloth 11 is made from a single piece of mesh fabric made of artificial fiber. The upper half has a trapezoidal shape, narrowing toward a top end, while the lower half has a longitudinal rectangular shape. Except on a top end portion, reinforcing strips 12 are sewn onto the outer edges of the rear side of the base cloth 11. In the middle portions of the left and right edges of the base cloth 11, straps 13 are sewn onto the reinforcing strips 12, and in the lower portions thereof, straps 14 are sewn onto the reinforcing strips 12. In the areas where the straps 13, 14 are sewn on, two layers of the reinforcing strips 12 are used, and resin plates (indicated by broken lines) are inserted between the two layers of the reinforcing strips 12. On the front and rear sides of a bottom end portion of the base cloth 11, cushions 25 made of foam resin, the outside faces of which are covered with a mesh fabric made of artificial fiber, are sewn onto a bottom edge. A cloth tape 15 is sewn onto the center in the widthwise direction of the rear side of the base cloth 11, from the top end to the bottom end, to indicate the center of the sling seat 10.

The top end portion of the base cloth 11 is folded back toward the rear side, and the end edge is sewn onto the base cloth 11 to form a tubular shape. The pillow 16 is made of foam resin having a vertical dimension of about 10 to 12 centimeters and a horizontal width of about 35 to 50 centimeters. The pillow 16 is inserted into the aforementioned tubular shape in the base cloth 11 and is attached by stitching at both lateral ends such that the attachment position cannot change. The pillow 16 is folded back toward the rear side of the sling seat such that the vertical position of the pillow 16 can be adjusted by wrapping the base cloth 11 around the pillow 16 so that the position of the pillow 16 matches the actual body size of the person in the seat. Loop-shaped straps 17 are sewn onto the base cloth 11 as coupling devices at immediate both lateral ends of the pillow 16.

As coupling members to couple the sling seat 10 with a hanging member 91 of a care lift 90, four adjustable straps 18, 19 and two adjustable neck straps 21 are used. The adjustable straps 18 are bound to the straps 13 that are sewn onto the middle portions of the left and right edges of the base cloth 11, and the adjustable straps 19 are bound to the straps 14 that are sewn onto the lower portion of the left and right edges of the base cloth 11.

As shown in FIG. 5B, each of the adjustable straps 18, 19 consists of a loop-shaped webbing strap 24 formed by sewing together both ends, and three intermediate webbing straps 20 that span the two sides of the loop-shaped webbing strap 24. Each adjustable strap 18, 19 has a ladder shape by spanning the two sides of the loop-shaped webbing strap 24 with the three intermediate webbing straps 20. To prevent the adjustable straps 18, 19 from twisting at the point of binding to the straps 13, 14 when the adjustable straps 18, 19 are bound to the straps 13, 14, the webbing strap 24 is given a half-twist at the end of each adjustable strap 18, 19 that is bound respectively to each strap 13, 14 before the ends of the webbing strap 24 are sewn together to form the loop. Because both ends of each intermediate webbing strap 20 are sewn to the corresponding webbing strap 24, each intermediate webbing strap 20 spans an adjustable strap 18, 19. Note that in this embodiment, the number of intermediate webbing straps 20 spanning each adjustable strap 18, 19 is three, but in consideration of the lengths and the like of the adjustable straps, the number of intermediate webbing straps 20 spanning each adjustable strap 18, 19 may be increased or decreased. Also, the number of intermediate webbing straps 20 spanning the adjustable straps 18 which are bound to the straps 13 may be different from the number of intermediate webbing straps 20 spanning the adjustable straps 19 which are bound to the straps 14.

To each of the straps 17 sewn onto the middle portions of the left and right ends of the pillow 16, an adjustable neck strap 21 is bound for supporting the pillow 16. The other end of each of the adjustable neck straps 21 is joined to one of the adjustable straps 18, 19 which are respectively bound to the straps 13, 14 on the side edges of the base cloth.

As shown in FIG. 5A, the adjustable neck strap 21 is made of a webbing, and a metal hook 22 in the shape like that two triangles butt each other at their vertexes is attached to the outer end of the adjustable neck strap 21 which is not bound to the strap 17. A clip 23 in the shape of a rectangular frame with two crossbars is mounted in the center of each adjustable neck strap 21. A loop is formed at the base end of the adjustable neck strap 21 by passing the end that is not the outer end through the clip 23. The adjustable neck straps 21 are bound by the loops to the straps 17 sewn onto the middle portions of the left and right ends of the pillow 16.

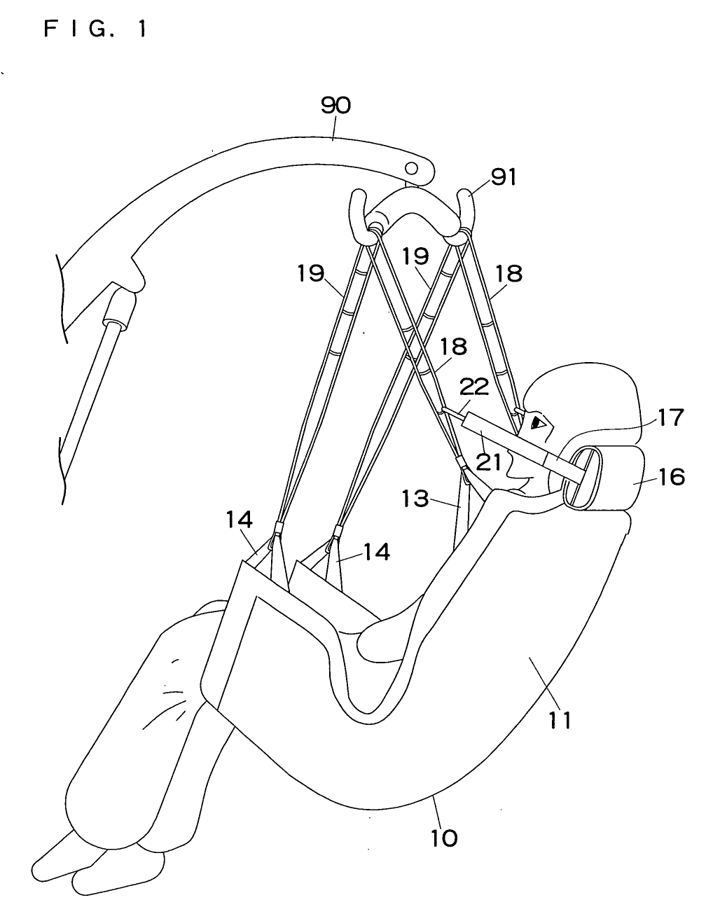

The in-use state (lifted state) of the sling seat 10 in this embodiment will be described with reference to FIGS. 1 to 3C.

As shown in FIG. 1, when the sling seat 10 is in use, the outer ends of the adjustable straps 18, 19, which are bound to the middle and lower portions of the side edges of the base cloth, are hooked onto the hanging member 91 of the care lift 90, and the person in the seat is enveloped from the back to the thighs by the sling seat 10. Note that in FIG. 1, the outermost end of each of the adjustable straps 18, 19 is hooked onto the hanging member 91 of the care lift 90, but in consideration of the posture of the person sitting in the seat, the intermediate webbing straps 20, which are provided such that the adjustable straps 18, 19 assume a ladder shape, may be hooked onto the hanging member 91 of the care lift 90 instead.

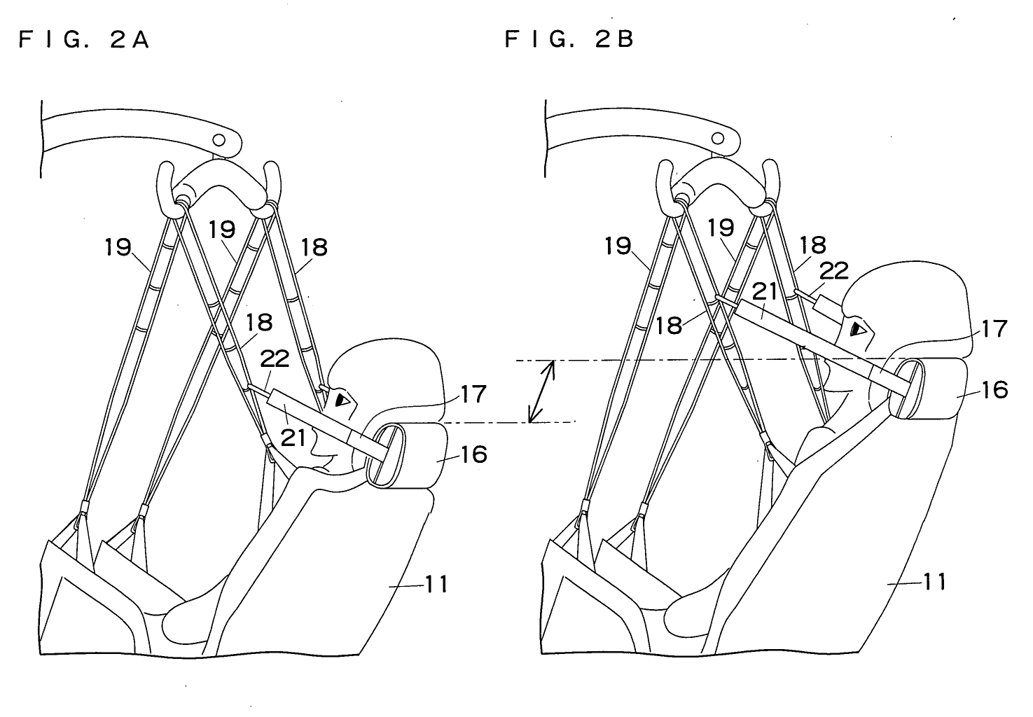

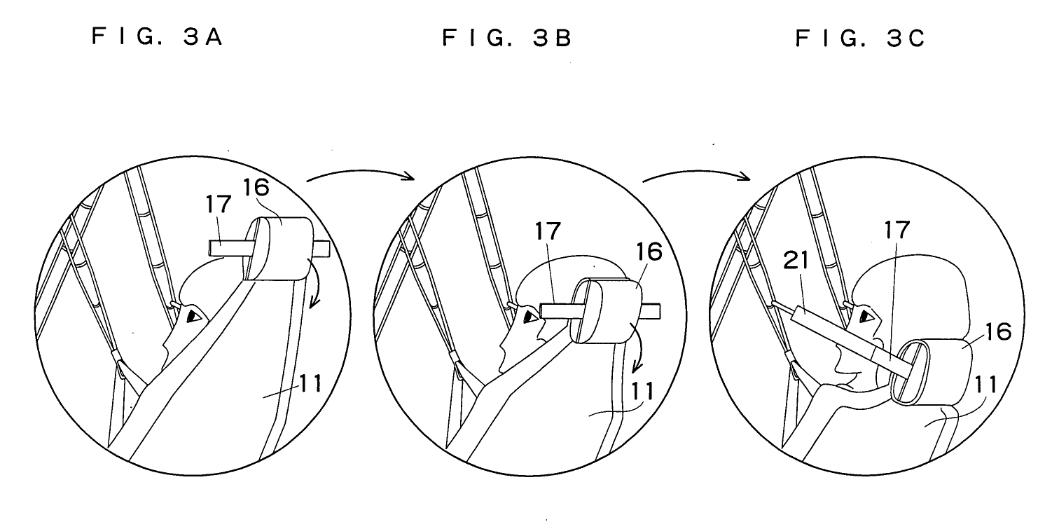

As shown in FIG. 2A, when the actual physique of the person in the seat is small, the pillow 16 is folded back toward the rear side of the sling seat, as shown in FIGS. 3A to 3C, such that the base cloth 11 is wrapped around the pillow 16 and the vertical position of the pillow 16 is lowered until the pillow 16 makes contact with the back of the head of the person in the seat. Also, as shown in FIG. 2B, when the actual physique of the person in the seat is large, the base cloth 11 is unwrapped from around the pillow 16 and the vertical position of the pillow 16 is raised until the pillow 16 makes contact with the back of the head of the person in the seat. Note that the base cloth 11 can be completely unwrapped and fully extended, such that the pillow 16 does not make contact with the back of the head of the person in the seat and the sling seat can be used as a conventional full type sling seat.

Note that instead of the base cloth 11 being wrapped around the pillow 16 as described above, a vertically long hook-and-loop fastener half 51 may be provided on the upper portion of the base cloth 11, with a hook-and-loop fastener other half 52 being provided on the rear face of the pillow 16, such that the vertical position of the pillow 16 can be adjusted by attaching the hook-and-loop fastener half 52 removably (such that the attachment position can be changed) to the hook-and-loop fastener half 51 at a suitable height.

As shown in FIGS. 1, 2A and 2B, to support the pillow 16, the hooks 22 which are attached to the outer ends of the adjustable neck straps 21 which are bound to the straps 17 which are sewn onto the middle portions of the left and right ends of the pillow 16, are engaged with the adjustable straps 18 which are bound to the straps 13 in the middle portions of the left and right edges of the base cloth 11.

Also, in FIGS. 2A and 2B, the positions at which the hooks 22 are engaged with the adjustable straps 18 differ according to differences in the physique of the person in the seat. Note that in FIGS. 1, 2A and 2B, the hooks 22 are engaged with the adjustable straps 18 which are bound to the straps 13 in the middle portions of the left and right edges of the base cloth, but in consideration of the posture of the person sitting in the seat, the hooks 22 may be engaged with the adjustable straps 19 which are bound to the straps 14 in the lower portions of the left and right edges of the base cloth. Moreover, in order for the hanging member 91 of the care lift 90 to directly support the pillow 16, ends of webbing straps (not shown) other than the adjustable neck straps 21 may be passed through the straps 17 at the middle portions of the left and right ends of the pillow 16 and engaged with the hanging member 91.

According to this embodiment, the following effects can be obtained.

(a) The head and neck of the person in the seat can be held stably when the seat is lifted, by bringing the pillow 16, which is attached to the base cloth 11, into contact with the back of the head of the person in the seat.

(b) The pillow 16 can be fitted to the back of the head of the person in the seat, whether the person in the seat has a large or small physique, by wrapping the base cloth 11 around the pillow 16 to adjust the vertical position of the pillow 16 to match the physique of the person in the seat. The back of the head of the person in the seat does not slip out of position, because all slack is taken out of the base cloth 11 by wrapping it around the pillow 16.

(c) The state of the head and neck of the person in the seat can be adjusted by using the clips 23 that are mounted on the adjustable neck straps 21 to adjust the lengths of the adjustable neck straps 21.

(d) Because the sling seat 10 is lifted using the ladder-shaped adjustable straps 18, 19, for which the positions of engagement with the hanging member 91 of the care lift 90 can be adjusted, the posture of the person in the seat can be adjusted.

(e) The angle of the pillow 16 can be adjusted by engaging the hooks 22 at the outer ends of the adjustable neck straps 21 with the ladder-shaped adjustable straps 18 or 19.

(f) Because the hooks 22 are engaged with the adjustable straps 18, person's neck and trunk can be lifted at the same time so that the burden on the neck can be reduced.

(g) The sling seat 10 can be prevented from being held on only one side at the bottom or the top by binding the adjustable straps 18, 19 to the straps 13, 14 that are sewn onto the left and right sides of the sling seat 10.

### Second Embodiment

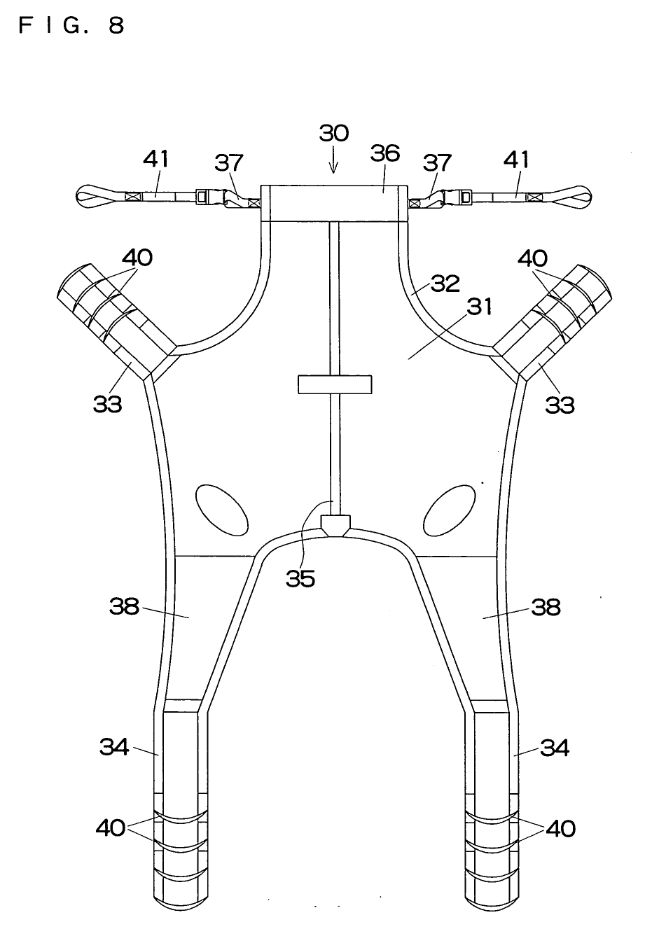

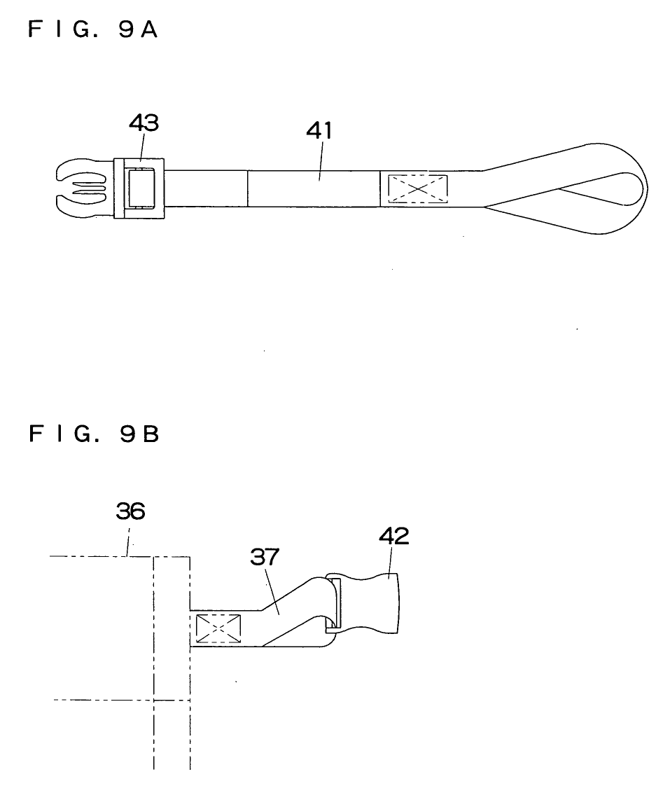

A sling seat 30 according to a second embodiment, shown in FIGS. 8, 9A and 9B, differs from the first embodiment in that the lower portion of the a base cloth 31 is divided into two sections that form leg-holding portions 38, which wrap around the thighs of the person in the seat. A pillow 36, the same type of pillow as that used in the first embodiment, is also provided.

The base cloth 31 is made from a single piece of woven fabric made of artificial fiber. The upper portion has a trapezoidal shape, narrowing toward a top end, while the lower portion has a generally lateral rectangular shape. A cloth tape 35 is sewn onto the center in the widthwise direction of the rear side of the base cloth 31, from the top end to the bottom end, to indicate the center of the sling seat 30.

The leg-holding portions 38 both narrow toward the bottom ends. Cushions whose outer surfaces are covered with the same woven fabric as the base cloth 31 or the like are sewn onto the undersides of the leg-holding portions 38.

Reinforcing strips 32 are sewn onto the outer edges of the base cloth 31 and the leg-holding portions 38. The reinforcing strips 32 extend to areas where there is no fabric, forming straps 33 at both upper corners of the rectangular lower portion of the base cloth 31 and forming straps 34 at both bottom ends of the leg-holding portions 38.

The pillow 36 is attached to the upper portion of the base cloth 31 in the same manner as the pillow in the first embodiment. Straps 37 are sewn onto the middle portions of the left and right ends of the pillow 36. To each of the straps 37, an adjustable neck strap 41 is attached. As shown in FIG. 9B, a buckle receiving portion 42 is attached to the outer end of each of the straps 37, such that a buckle insertion portion 43, which is mounted on each of the adjustable neck straps 41, fits into the buckle receiving portion 42.

Three intermediate webbing straps 40 span each of the straps 33, 34, which are provided on the base cloth 31 and the leg-holding portions 38, respectively. Both ends of each intermediate webbing strap 40 are sewn to the respective strap. This causes the straps 33, 34 to assume a ladder shape.

As shown in FIG. 9A, the adjustable neck strap 41 is made of a webbing. One end of the adjustable neck strap 41 is given a half-twist to prevent twisting at the point of binding and formed into a loop. The buckle insertion portion 43, which is fitted into the buckle receiving portion 42, which is attached to the outer end of the strap 37, which is sewn to the middle portion of a lateral end of the pillow 36, is mounted in the middle of the adjustable neck strap 41. At the other end of the adjustable neck strap 41, the webbing strap is doubled over and sewn together to prevent the buckle insertion portion 43 from slipping off of the adjustable neck strap 41. The part of the buckle insertion portion 43 through which the webbing strap passes is shaped into a rectangular frame with a single crossbar, which allows the length of the adjustable neck strap 41 to be adjusted.

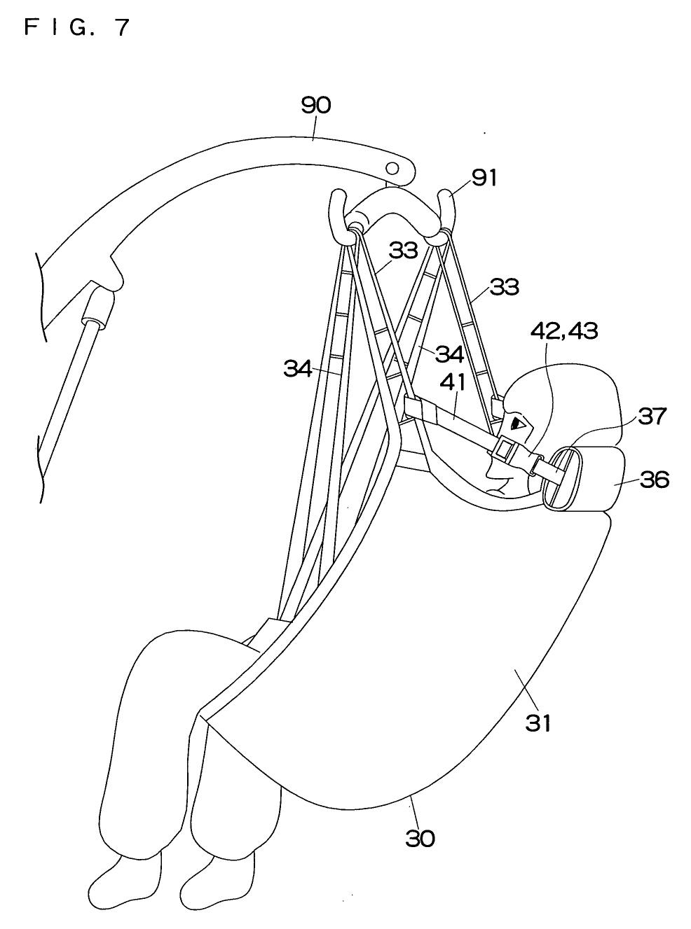

The in-use state (lifted state) of the sling seat 30 in this embodiment will be described with reference to FIG. 7.

When the sling seat 30 is in use, the outer ends of the straps 33 extending from both upper corners of the rectangular lower portion of the base cloth 31, and the outer ends of the straps 34 extending from both bottom ends of the leg-holding portions 38, are hooked onto the hanging member 91 of the care lift 90, and the person in the seat is enveloped from the back to the thighs by the sling seat 30. However, the straps 34, which extend from both bottom ends of the leg-holding portions 38, are crossed in front of the person in the seat such that the left and right straps respectively engage the right and left sides of the hanging member 91 of the care lift 90, so that the leg-holding portions 38 wrap around the thighs of the person in the seat and the person is lifted from between the thighs. Note that in FIG. 7, the outermost end of each of the straps 33, 34 is hooked onto the hanging member 91 of the care lift 90, but in consideration of the posture of the person sitting in the seat, the intermediate webbing straps 40, which are provided such that the straps 33, 34 assume a ladder shape, may be hooked onto the hanging member of the care lift 90 instead.

The position of the pillow 36 is adjusted to match the physique of the person in the seat by folding the pillow 36 back toward the rear side of the sling seat 30 and wrapping the base cloth 31 around the pillow 36 such that the pillow 36 makes contact with the back of the head of the person in the seat and holds the person's head and neck.

To support the pillow 36, the adjustable neck straps 41 are bound to the straps 33 by binding the loops that are formed at one end of the adjustable neck straps 41 to the straps 33, and the buckle insertion portions 43 are fitted into the buckle receiving portions 42, which are attached to the outer ends of the straps 37 on the pillow 36.

The same effects (a) to (f) that were obtained by the first embodiment can be obtained by the second embodiment. The differences among these effects from the first embodiment are as follows: in (c), the length of the adjustable neck strap 41 is adjusted by the buckle insertion portion 43; in (d), the ladder-shaped adjustable straps 33, 34 are used; in (e) and (f), the adjustable neck straps 41 are bound to the ladder-shaped straps 33, 34 by binding the loops that are formed at one end of each of the adjustable neck straps 41 to the straps 33, 34. Also, according to the second embodiment, the following effect (h) can be obtained:

(h) The straps 34, which extend from both bottom ends of the leg-holding portions 38, are crossed in front of the person in the seat such that the left and right straps 34 respectively engage the right and left sides of the hanging member 91 of the care lift 90, so that the person in the seat can be prevented from falling out of the sling seat 30 while the seat is being lifted.

### Third Embodiment

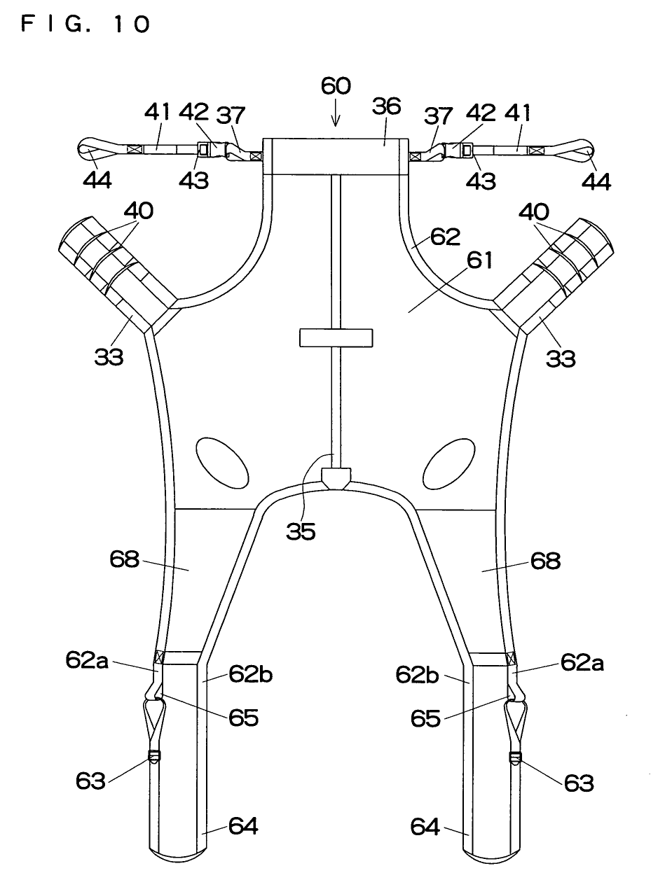

A sling seat 60 according to a third embodiment, shown in FIG. 10, is different from the second embodiment only in the mode of the straps that are provided on the leg-holding portions, and identical to the second embodiment in others. Therefore, a strap 64 provided on the leg-holding portion 68 will be mainly described below.

The strap 64 is formed at a bottom end of each leg-holding portion 68 by extending reinforcing strip 62 downward to areas where there is no fabric. The strap 64 each includes a reinforcing strip 62a that is extended from the outer bottom end of the leg-holding portion 68, and a reinforcing strip 62b that is extended from the inner bottom end of the leg-holding portion 68. A loop 65 is formed at the tip end of the reinforcing strip 62a. A clip 63 in the shape of a rectangular frame with two crossbars is mounted on the reinforcing strap 62b. By passing the reinforcing strip 62b through the loop 65 of the strip 62a, and attaching the outer end of the strip 62b to the clip 63, the reinforcing strips 62a, 62b are connected with each other to form the strap 64.

The same effects (a) to (c), (e), and (f) that were obtained by the first embodiment can be obtained by the third embodiment. The differences among these effects from the first embodiment are as follows: in (c), the length of the adjustable neck strap 41 is adjusted by the buckle insertion portion 43; in (e) and (f), the adjustable neck straps 41 are bound to the ladder-shaped straps 33 or the straps 64 provided on the leg-holding portions 68 by binding the loops 44 that are formed at one end of each of the adjustable neck straps 41. Also, the same effect (h) that was obtained by the second embodiment can be obtained by the third embodiment. In addition, according to the third embodiment, the following effect (i) can be obtained:

(i) The posture of the person in the seat can be adjusted more finely by changing the positions at which the clips 63 are mounted on the straps 64 which extend from the both bottom ends of the leg-holding portions 68 to change the lengths of the straps 64 continuously.

### Fourth Embodiment

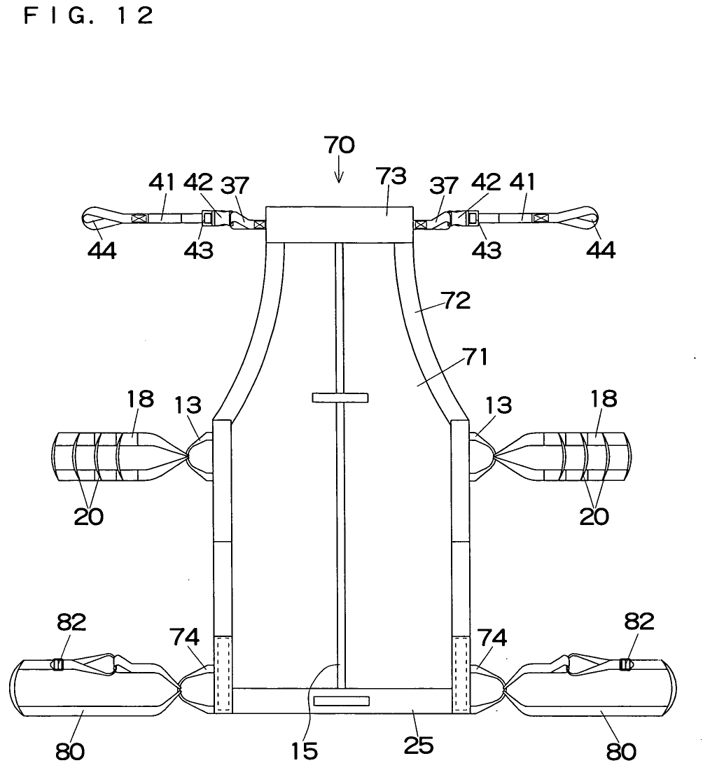

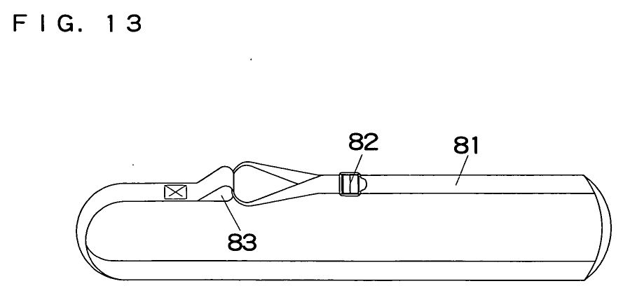

A sling seat 70 according to a fourth embodiment, shown in FIGS. 12 and 13, is different from the first embodiment in the mode of adjustable straps 80 that are bound to the straps 74 that are sewn onto the lower portion of the left and right edges of the base cloth, and adjustable neck strap 41 that are bound to the straps 37 that are sewn onto the middle portions of the left and right ends of a pillow 73, and identical to the first embodiment in others. Since the straps 37 and adjustable neck strap 41 are identical to the second embodiment, the adjustable straps 80 provided on the lower portion of the left and right edges of the base cloth 71 will be mainly described below.

Adjustable straps 80 that are bound to straps 74 sewn onto the lower portion of the left and right edges of the base cloth 71 includes a webbing strap 81 and a clip 82 in the shape of a rectangular frame with two crossbars that is mounted on the webbing strap 81. One end of the webbing strap 81 is formed into a loop 83. By passing the webbing strap 81 through this loop 83 and attaching the other end of the webbing strap 81 to the clip 82, the adjustable strap 80 is formed into a loop-shape. To prevent the adjustable strap 80 from twisting at the point of binding to the strap 74 when the adjustable strap 80 is bound to the strap 74, the webbing strap 81 is given a half-twist to form the loop.

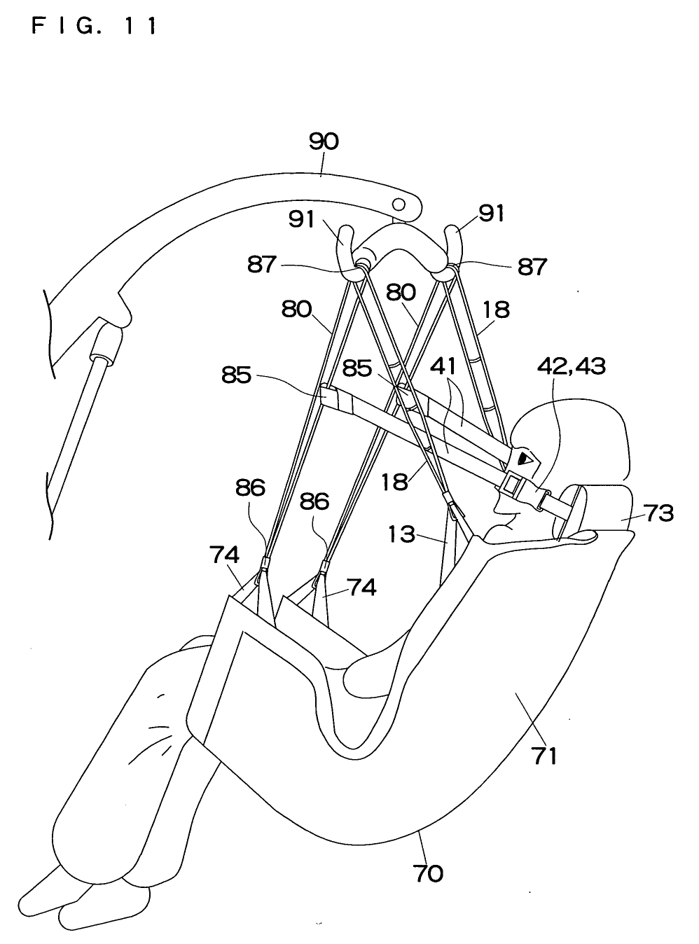

As shown in FIG. 11, when the sling seat 70 is in use, the outer ends of the adjustable straps 18, 80, which are bound to the middle and lower portions of the side edges of the base cloth, are hooked onto the hanging member 91 of the care lift 90, and the person in the seat is enveloped from the back to the thighs by the sling seat 70. The adjustable neck strap 41 is bound to the adjustable strap 80 at the portion that is nearer to the adjustable neck strap 41 so as not to slide.

Thus, the adjustable strap 80 is tensioned by three points, which are the first binding point 85 where is bound to the adjustable neck strap 41, the second binding point 86 where is bound to the strap 74, and a hooking portion 87 where is hooked onto the hanging member 91. The position of the pillow 73 is adjusted to match the physique of the person in the seat by shifting the pillow 73 to give slack to the base cloth 71 in the area below the pillow 73.

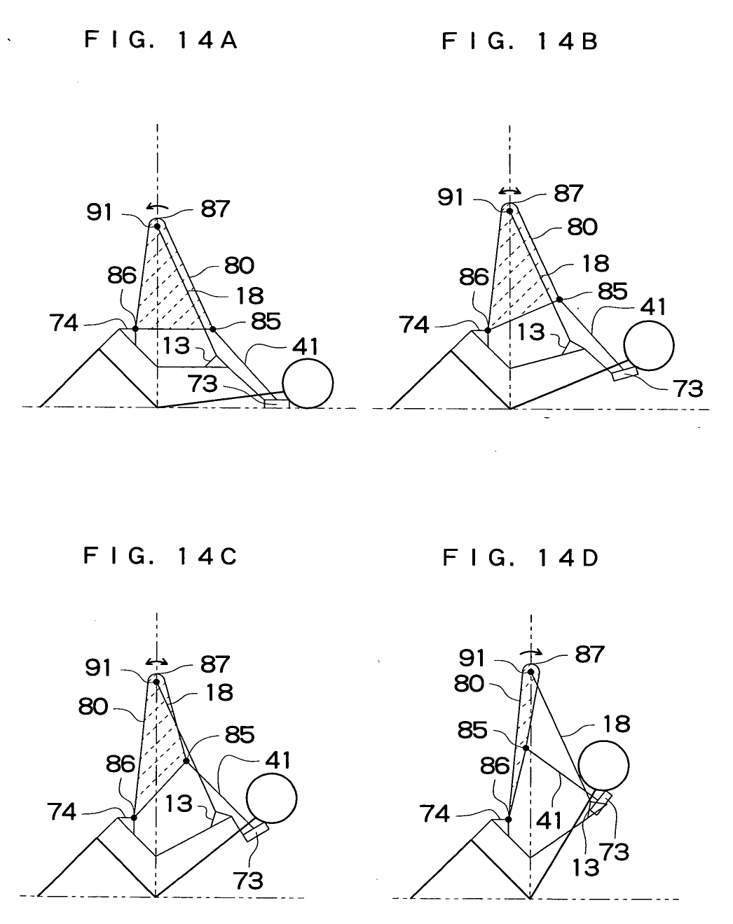

As shown in FIGS. 14A to 14D, as the hanging member 91 of the care lift 90 moves up, each adjustable strap 18, 41, 80 is tensioned, and hence the person in the seat is going to be lifted. The adjustable strap 80 is tensioned by the three points as described above, and is slidable in its longitudinal direction on the hanging member 91. Therefore, the hooking portion 87 shifts in the adjustable strap 80 as the hanging member 91 moves up until the person in the seat is lifted entirely. Thus, the first binding point 85 moves not only in the vertical direction but also in the horizontal direction to approach the hanging member 91, and therefore, a force is applied to the adjustable neck strap 41 not only in the vertical direction but also in the horizontal direction. Thereby, the upper half of the body of the person in the seat is raised with a buttock as a fulcrum. When the hanging member 91 moves down, contrary to the above, the upper half of the body of the person in the seat is laid down with the buttock as a fulcrum.

The same effects (a), (c), (e), and (g) that were obtained by the first embodiment can be obtained by the fourth embodiment. The differences among these effects from the first embodiment are as follows: in (c), the length of the adjustable neck strap 41 is adjusted by the buckle insertion portion 43; in (e), the adjustable neck straps 41 are bound to the loop-shaped adjustable strap 80 by binding the loop 44 that are formed at one end of each of the adjustable neck straps 41. Also, the same effect (h) that was obtained by the third embodiment can be obtained by the fourth embodiment. In addition, according to the fourth embodiment, the following effect (j) can be obtained:

(j) The adjustable strap 80 is tensioned by three points, which are the first binding point 85 bound to the adjustable neck strap 41, the second binding point 86 bound to the strap 74, and the hooking portion 87 hooked onto the hanging member 91. In addition, the hooking portion 87 can be shifted in the loop-shaped the adjustable strap 80. Accordingly, the upper half of the body of the person in the seat can be easily raised or laid down by the vertical motion of the care lift 90.

Note that the present invention is not limited by the embodiments described above. The present invention can be practiced by making suitable changes to the configuration of any portion within the scope of the invention.

What is claimed is:

1. A sling seat, comprising:
a base cloth formed sufficiently long at a top to reach a head of a person requiring nursing care with a large physique who sits in the seat; and
a pillow for supporting a back of the head of the person requiring nursing care in the seat so that the back of the head does not sink into an upper portion of the base cloth;
wherein the pillow is attached to the upper portion of the base cloth, and a vertical position of the pillow can be adjusted to match an actual body size of the person requiring nursing care in the seat.

2. The sling seat according to claim 1, wherein the pillow is attached to a top end of the upper portion of the base cloth, and the vertical position of the pillow can be adjusted by wrapping the base cloth around the pillow.

3. The sling seat according to claim 2, wherein the sling seat further comprises at least two coupling members for lifting the sling seat, and the two coupling members can be coupled to the base cloth at immediate both lateral sides of the pillow.

4. The sling seat according to claim 3, wherein the two coupling members are directly coupled to the base cloth at immediate both lateral sides of the pillow.

5. The sling seat according to claim 3, wherein the two coupling members can be coupled to coupling devices that are attached to the base cloth at immediate both lateral sides of the pillow.

6. The sling seat according to claim 1, wherein the pillow has a vertical dimension of from 5 to 18 centimeters.

7. The sling seat according to claim 2, wherein the pillow has a vertical dimension of from 7 to 15 centimeters.

8. The sling sheet according to claim 1, wherein the sling sheet further comprises:
two lower coupling members for lifting the sling seat that are coupled to the lower portions of the base cloth, each of the lower coupling members being formed into a loop-shape so that the lower coupling members can be hooked slidably in a longitudinal direction thereof onto a hanging member of a care lift; and
two upper coupling members for lifting the sling seat that are coupled to the base cloth at immediate both lateral sides of the pillow, each of the upper coupling members being designed to be connected to the lower coupling member at a nearer side to the upper coupling member.

9. A method of using a sling seat, comprising:
enveloping a person requiring nursing care in the seat from a back to thighs by the sling seat having a base cloth formed sufficiently long at the top to reach a head of the person requiring nursing care with a large physique, and a pillow attached to a top end of an upper portion of the base cloth for supporting a back of the head of the person requiring nursing care in the seat so that the back of the head does not sink into the upper portion of the base cloth;
wrapping the upper portion of the base cloth around the pillow; and
adjusting a vertical position of the pillow to match the actual body size of the person requiring nursing care in the seat by an adjustment pitch at each half-wrapping.
